(19) United States
(12) Patent Application Publication
(10) Pub. No.: US 2026/0329299 A1
(43) Pub. Date: Oct. 22, 2026

(54) PROPULSION VEHICLE SPEED CONTROL BASED ON PLANTER CHARACTERISTICS

(71) Applicant: Deere & Company, Moline, IL (US)

(72) Inventors: Iuri N DE JESUS, Indaiatuba (BR); Travis M. HINTON, Davenport, IA (US); Matheus P. VIEIRA, Indaiatuba (BR); Armando PERICO, Indaiatuba (BR); Emanuel Victor Borges de Morais CRUVINEL, Indaiatuba (BR); Miguel Angel Salgado HERRERA, Campinas (BR); Regina Marcela IVO, Indaiatuba (BR); Renan SILVA, Campinas (BR)

(21) Appl. No.: 19/184,767

(22) Filed: Apr. 21, 2025

(51) Int. Cl. G05D 1/65; A01C 11/00; G05D 105/15

(52) U.S. Cl. CPC G05D 1/65; A01C 11/006; G05D 2105/15

(57) ABSTRACT

A set of planting parameters is sensed, and a speed optimization state is generated by evaluating the planting parameters. A speed control system controls planter speed based on the speed optimization state.

### FIELD OF THE DESCRIPTION

The present description relates to agricultural machines. More specifically, the present description relates to controlling planting speed based on sensed planting parameters.

### BACKGROUND

There is a wide variety of different types of agricultural machines that apply material to an agricultural field. Some such agricultural machines include sprayers, tillage machines with side dressing bars, air seeders, and planters that have row units, among others.

As one example, a row unit is often mounted to a planter with a plurality of other row units. The planter is often towed by a tractor or moved over soil by another propulsion vehicle where seed is planted in the soil, using the row units. The row units on the planter follow the ground profile by using a combination of a down force assembly that imparts a down force to the row unit to push disk openers into the ground and gauge wheels to set depth of penetration of the disk openers.

Row units can also be used to apply material to the field (e.g., fertilizer to the soil, to a seed, etc.) over which the row units are traveling. In some scenarios, each row unit has a valve that is coupled between a source of material to be applied, and an application assembly. As the valve is actuated, the material passes through the valve, from the source to the application assembly, and is applied to the field.

Air seeders have an air cart with one or more central seed or commodity tanks. The seed or commodity in the tank is metered by a metering system or a dispensing system into common product delivery tubes called “primaries”. The seed or commodity is delivered (using air delivery) to a tool for disbursement. The tool disburses the product into secondary tubes which deliver the product to individual furrows opened by the tool. The furrows are opened by a furrow opener and closed after seed is delivered to the furrow by a closer.

The discussion above background is merely provided for general background information and is not intended to be used as an aid in determining the scope of the claimed subject matter.

### SUMMARY

A set of planting parameters is sensed, and a speed optimization state is generated by evaluating the planting parameters. A speed control system controls planter speed based on the speed optimization state.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a side view of an agricultural architecture with one example of a planting machine, shown in a partial pictorial and partial schematic form.

FIG. 2 is a top view of an agricultural architecture with one example of a planting machine, shown in a partial pictorial and partial schematic form.

FIG. 3 is a side view showing one example of a row unit of the planting machine illustrated in FIG. 2.

FIG. 4 is a side view showing another example of a row unit of the planting machine illustrated in FIG. 2.

FIG. 5 is a view of an application unit.

FIG. 6 is a block diagram of one example of an agricultural system.

FIG. 7 shows a flow diagram illustrating one example of the operation of the agricultural system.

FIG. 8 shows a flow diagram illustrating one example of the operation of the agricultural system.

FIG. 9 shows one example of the agricultural system, deployed in a remote server environment.

FIGS. 10, 11, and 12 show examples of mobile devices that can be used in the architectures and systems shown in other FIGS.

FIG. 13 is a block diagram showing one example of a computing environment that can be used in the architectures shown in other FIGS.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, there are many types of application machines that apply material to a field. The material can include seed, fertilizer, insecticides, pesticides, herbicides, or another commodity. The ground speed at which the material application machine travels is often controlled by an operator. The optimal or desired ground speed that achieves optimal or desired planting or application results often varies depending upon the field conditions and planting conditions and other planting parameters. Those planting parameters can vary quickly as the application machine operates. Thus, the operator often needs to manually and continually adjust the ground speed of the propulsion vehicle (e.g., the tractor) to maintain desirable planting or application results.

In addition to requiring substantially constant and continuous operator inputs, setting the ground speed during a planting operation often requires a high level of operator skill and experience in assessing the planting conditions and the operation of the planter. The operator often needs to consider different conditions to set the ground speed for desirable operation. Such conditions can include variable soil conditions (which can even change from row unit to row unit across the planter), the current planter operating conditions, the optimal engine speed for the propulsion vehicle (e.g., the tractor) to achieve fuel efficiency, planter settings (such as down force), among others.

In some examples, the propulsion vehicle (e.g., the tractor) has a speed control system. The operator can input a speed set point and the speed control system acts as a cruise control system to maintain the ground speed of the propulsion vehicle based upon the speed set point. To maintain desired planting operation, the operator must substantially continuously evaluate and update the speed set point based upon the planting conditions.

The present description thus proceeds with respect to a system that detects a plurality of different planting conditions that may affect the desired speed of the planter. Such conditions can include, for instance, applied downforce, ride quality, pressure in the commodity being applied, wheel slip, soil conditions, among other conditions. A speed optimization state generation system receives an indication of the sensed planting conditions and generates a speed optimization state signal indicating whether the ground speed should be increased, decreased, or maintained based on the planting conditions. The speed optimization state signal is provided to the speed control system which controls the ground speed of the propulsion vehicle. The speed control system automatically controls the ground speed of the propulsion vehicle (and thus the planter) based upon the speed optimization state signal. In this way, the ground speed of the planter is automatically controlled based upon the sensed planter conditions. By automatically, it is meant, in one example, that the step, operation, or function is performed without further operator involvement except, perhaps, to initiate or authorize the step, operation, or function.

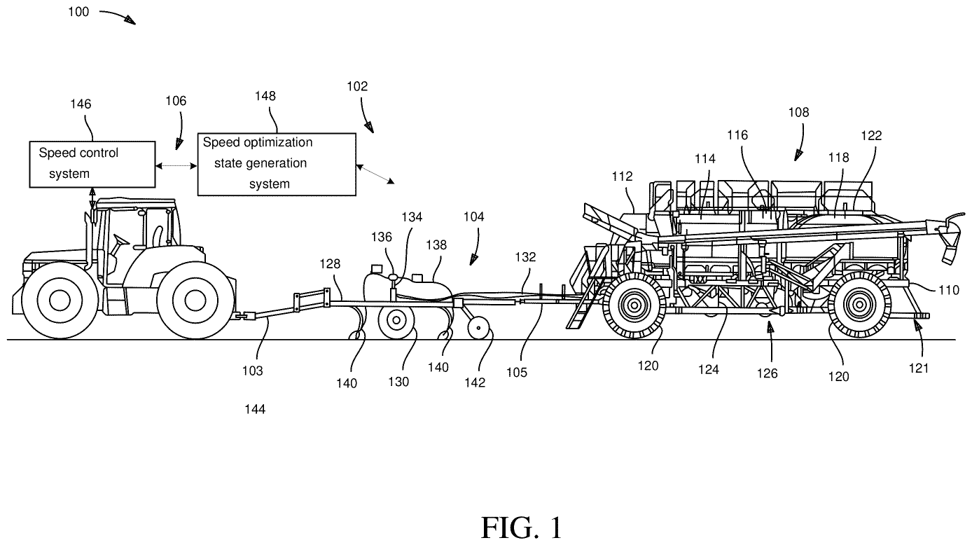

FIG. 1 is a side view of one example of an agricultural system 100 which includes an agricultural implement, in particular an air or pneumatic seeder 102. In the example shown in FIG. 1, the seeder 102 comprises a tilling implement (also referred to as a material application implement or drill or seeding tool) 104 towed between a tractor (or other propulsion vehicle) 106 and a commodity cart (also sometimes called an air cart) 108. The commodity cart 108 has a frame 110 upon which a series of product tanks 112, 114, 116, and 118, and wheels 120 are mounted. There may be one or more tanks, and four tanks are shown in FIG. 1 as an example only. Each product tank has a door (a representative door 122 is labeled) releasably sealing an opening at the upper end of the tank for filling the tank with product, most usually seed or a commodity of one type or another. A dispensing system 124 is provided at a lower end of each tank (a representative one of which is labeled in FIG. 1 and others are shown and described elsewhere herein) for controlled feeding or draining of product (most typically granular material) into a pneumatic distribution system or delivery system 126. The tanks 112, 114, 116, and 118 can hold, for example, a material or commodity such as seed or fertilizer to be distributed to the soil. The tanks can be hoppers, bins, boxes, containers, etc. The term “tank” shall be broadly construed herein. Furthermore, one tank with multiple compartments can also be provided instead of separate tanks.

The seeding tool 104 includes a frame 128 supported by ground engaging wheels 130. Frame 128 is connected to a leading portion of the commodity cart 108, for example by a tongue style attachment (not labeled). The commodity cart 108 as shown is sometimes called a “tow behind cart,” meaning that the cart 108 follows the seeding tool 104. In an alternative arrangement, cart 108 can be configured as a “tow between cart,” meaning the cart 108 is between the tractor 106 and seeding tool 104. In yet a further possible arrangement, the commodity cart 108 and seeding tool 104 can be combined to form a unified rather than separated configuration. These are just examples of additional possible configurations. Other configurations are even possible, and all configurations should be considered contemplated and within the scope of the present description.

In the example shown in FIG. 1, tractor 106 is coupled by couplings 103 to seeding tool 104 which is coupled by couplings 105 to commodity cart 108. The couplings 103 and 105 can be mechanical, hydraulic, pneumatic, and electrical couplings, and/or other couplings. The couplings 103 and 105 can include wired and wireless couplings as well.

The pneumatic distribution system 126 includes one or more fans or blowers located generally at 121 connected to a product delivery conduit structure having multiple product flow passages referred to as primary delivery tubes 132. The fan directs air through the primary delivery tubes 132. Each product dispensing system 124 controls delivery of product from its associated tank at a controllable rate to the transporting airstreams moving through primary delivery tubes 132. In this manner, each flow passage defined by each primary delivery tube 132 carries product from one or more of the tanks to a secondary distribution tower 134 on the seeding tool 104. There may be one tower 134 for each primary delivery tube 132. Each tower 134 includes a secondary distributing manifold 136, which may be located at the top of a vertical tube. The secondary distributing manifold 136 divides the flow of product into several secondary distribution tubes 138. Each secondary distribution tube 138 delivers product to one of a plurality of ground engaging tools 140 (also known as ground openers or furrow openers) that define the locations of work points on seeding tool 104. The ground engaging tools (or furrow openers) 140 open a furrow in the soil 144 and facilitate deposit of the product therein. The number of primary delivery tubes 132 that feed into secondary distribution may vary from one to eight or ten or more, depending at least upon the configuration of the commodity cart 108 and seeding tool 104. Depending upon the cart and implement, there may be two distribution manifolds 136 in the air stream between the dispensers 124 and the ground engaging tools 140. Alternatively, in some configurations, the product is metered or dispensed directly from the tank or tanks into secondary distribution lines that lead to the ground engaging tools 140 without any need for an intermediate distribution manifold. The product dispensing system 124 can be configured to vary the rate of delivery of seed or other material to each work point on seeding tool 104 or to different sets or zones or sections of work points on seeding tool 104. The configurations described herein are only examples. Other configurations are possible and should be considered contemplated and within the scope of the present description.

A firming or closing wheel 142 associated with each seeding tool 140 trails the tool and firms the soil over the product deposited in the soil. In practice, a variety of different types of tools 140 are used including, but not necessarily limited to, tines, shanks and disks. Tools 140 are typically moveable between a lowered position engaging the ground and a raised position riding above the ground. Each individual tool 140 may be configured to be raised by a separate actuator. Alternatively, multiple tools 140 (or sections of tools) may be mounted to a common component for movement together. In yet another alternative, the tools 140 may be fixed to the frame 128, the frame being configured to be raised and lowered with the tools 140.

Examples of air or pneumatic seeder 102 (seeder 102) described above should not be considered limiting. The features described in the present description can be applied to any seeder configuration, or other material application machine or material application implement, whether specifically described herein or not.

FIG. 1 shows that agricultural system 100 can also include a speed control system 146 and a speed optimization state generation system 148. In one example, speed control system 146 is deployed on tractor 106 and acts as a cruise control system to automatically control the propulsion system of tractor 106, to control the ground speed of tractor 106, based upon a speed set point. The speed set point can be input by an operator. The operator may be a manual operator, an automated operator, or a semi-automated operator.

Also, in the example shown in FIG. 1, agricultural system 100 includes speed optimization state generation system 148. System 148 may include a plurality of different sensors that sense planting conditions corresponding to seeder 102. Those planting conditions can include a wide variety of different types of planting conditions, such as forces or pressures on seeder 102, the ride quality of the different row units or portions of tool 104, the pressure of the seed or commodity being delivered, wheel slip on either seeder 102 or tractor 106 or both, the soil conditions of the soil being engaged by tool 104 (e.g., soil moisture, soil type, etc.) and/or any of a wide variety of other planting parameters. Speed optimization state generation system 148 also includes an optimization state output generator that generates a speed optimization state signal based upon the sensed planting parameters. The speed optimization state signal may be provided from system 148 to speed control system 146 and may indicate whether, based upon the planting conditions, the desired speed of tractor 106 should increase, decrease, or stay the same. Speed control system 146 can then automatically control the ground speed of tractor 106 (and hence the speed of seeder 102) based upon the speed optimization state signal. In this way, the speed of tractor 106 can be automatically controlled to accommodate for changing planting conditions in a fast, effective, substantially continuous, and efficient manner.

Also, it will be appreciated, that different portions of systems 146 and 148 can reside on tractor 106, on tool or implement 104, on a remote system, and/or on air cart 108, or all of the elements of systems 146 and 148 can be located at one place (e.g., on tractor 106). Elements of systems 146 and 148 can be distributed to a remote server architecture or located or distributed in other ways as well.

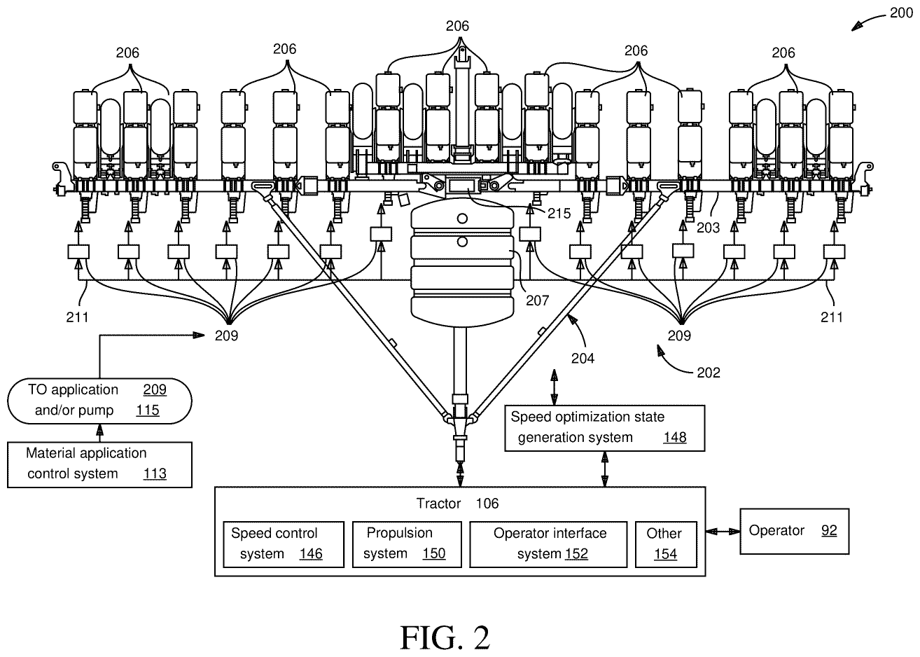

FIG. 2 is a partial pictorial, partial schematic top view of one example of an agricultural system or architecture 200. Some items in agricultural system 200 are similar to those shown in agricultural system 100 in FIG. 1 and similar items are similarly numbered. Agricultural system 200 includes agricultural planting machine 202, towing vehicle 106 (which is shown in block diagram form in FIG. 2), that is operated by operator 92, speed optimization state generation system 148, and material application control system 113, which can be deployed on one or more individual parts of machine 202, centrally located on machine 202, remotely located, distributed, or located on towing vehicle 106.

In the example shown in FIG. 2, towing vehicle 106 includes speed control system 146, propulsion system 150, operator interface system 152, and other items 154. Operator 92 (which can be a manual operator, an automated operator, or a semi-automated operator) can illustratively interact with operator interface system 152 to manipulate and control tractor 106, system 113, speed control system 146, propulsion system 150, speed optimization state generation system 148, and/or some or all portions of machine 202.

In the example shown in FIG. 2 machine 202 is a row crop planting machine that illustratively includes a toolbar 203 that is part of a frame 204. FIG. 2 also shows that a plurality of planting row units 206 are mounted to toolbar 203. Machine 202 can be towed behind tractor 106. FIG. 2 shows that material can be stored in a tank 207 (or material(s) can be stored in a plurality of tanks) and pumped through one or more supply lines 211 so the material can be dispensed or applied in or near the rows being planted. In one example, a set of applicators 209 is provided to perform the application operation. For instance, applicators 209 can include individual pumps that service individual row units 206 and that pump material from tank(s) 207 through supply line(s) 211 so the material(s) can be dispensed on the field. In such an example, material application control system 113 controls the pumps. Also, applicators 209 can include actuators that actuate valves or nozzles. One or more pumps 215 pump the material from tank(s) 207 to the valves or nozzles through supply line(s) 211. In such an example, material application control system 113 controls the actuators by generating actuator control signals to apply material according to a desired pattern, e.g., to apply a continuous strip of material, to apply material in an overlapping pattern, to apply material in a spaced pattern (e.g. on a per-seed basis), or in other ways.

As with the description with respect to FIG. 1 above, speed optimization state generation system 148 detects or receives sensor signals indicative of planting parameters corresponding to row unit planter 202. Speed optimization state generation system 148 can evaluate those parameters and generate a speed optimization state signal indicating whether the ground speed of planter 202 should be increased, decreased, or maintained the same based upon the planting parameters. The speed optimization state signal can be provided from system 148 to speed control system 146 which can control propulsion system 150 based upon the speed optimization state signal. The propulsion system 150 may be an internal combustion engine, a hydraulic motor, an electric motor, or another prime mover that drives ground engaging elements (such as wheels) of tractor 106 either directly or through a transmission.

For instance, where the speed optimization state signal indicates that the ground speed should be increased, then speed control system 146 can automatically control the propulsion system 150 to increase the ground speed of tractor 106 and hence of row unit planter 202. Similarly, where the speed optimization state signal indicates that the ground speed should be reduced, then speed control system 146 can automatically control propulsion system 150 to reduce the ground speed of tractor 106 and hence row unit planter 202. Some examples of how the planter conditions are valued and how the speed optimization state signal is generated and used to control 31 the ground speed of tractor 106 are described in greater detail elsewhere herein.

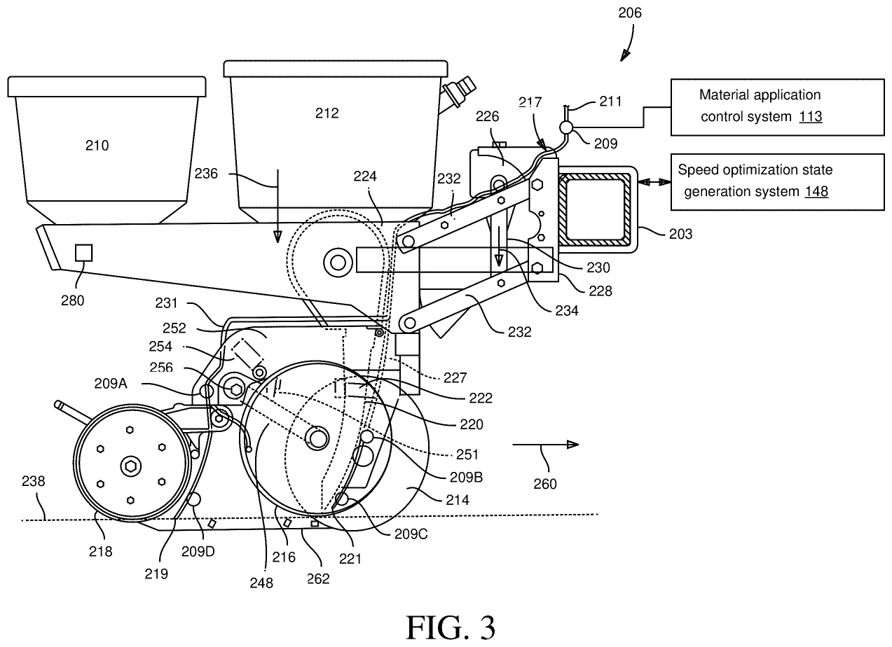

Some examples of the functionality on row units 206 will now be described with respect to FIGS. 3-5. FIG. 3 is a side view of one example of a row unit 206, with applicator 209 and system 113 shown as well. FIG. 3 shows that one or more applicators 209 can be in at least six possible locations labeled as 209, 209A, 209B, 209C, 209D, and 209E. It will be appreciated that row unit 206 may illustratively have a plurality of independently controllable applicators 209 that can be each located at one or more of the different locations indicated by numbers 209-209E or at other locations on row unit 206. Row unit 206 illustratively includes a chemical tank 210 and a seed storage tank 212. Row unit 206 also illustratively includes one or more disc openers 214, a set of gauge wheels 216, and a set of closing wheels 218. Seeds from tank 212 are fed into a seed meter 224, e.g., by gravity or from a centralized commodity distribution system (e.g., providing pneumatic commodity distribution to each row unit). The seed meter 224 controls the rate at which seeds are dropped into a seed tube 220 or other seed delivery system, such as a brush belt or flighted belt, from seed storage tank 212. The seeds can be sensed by seed sensor 222.

In the example shown in FIG. 3, liquid material is passed, e.g., pumped or otherwise forced, through one or more supply lines 211 to an inlet end of each applicator 209. Each applicator 209 is controlled by control system 113 to allow the liquid to pass from the inlet end of applicator 209 to an outlet end. Material application control system 113 senses the ground speed of row unit 206 (e.g., by sensing the ground speed of towing tractor 106 or in another way) and varies the control signal controlling applicator 209 based on the ground speed to maintain a desired application pattern. One example of the application of material through an applicator 209 will be discussed but it will be appreciated that the row unit 206 may have a plurality of independently controllable applicators 209 so one or more materials can be applied at different rates or according to different application patterns (e.g., continuously, overlapping, intermittently, etc.). By mentioning that the different applicators are actuated to apply material according to a different application pattern it is meant, for example, that one applicator is controlled to apply material at a different rate than another applicator, or that one applicator applies material according to one spatial pattern (such as continuously, or overlapping) that is different from a spatial pattern with which another applicator applies material (such as intermittently).

As liquid passes through each applicator 209, the liquid travels through an application assembly 217 from a proximal end (which is attached to an outlet end of each applicator 209) to a distal tip (or application tip) 219 where the liquid is discharged into a trench, or proximate a trench or furrow 262, opened by disc opener 214.

Some parts of row unit 206 will now be discussed in more detail. First, it will be noted that there are different types of seed meters 224, and the one that is shown is shown for the sake of example only. However, in one example, each row unit 206 need not have its own seed meter. Instead, metering or other singulation or seed dividing techniques can be performed at a central location, for groups of row units 206. The metering systems can include finger pick-up discs and/or vacuum meters (e.g., having rotatable discs, rotatable concave or bowl-shaped devices), among others. The seed delivery system can be a gravity drop system (such as seed tube 220 shown in FIG. 3 in which seeds are dropped through the seed tube 220 and fall (via gravitational force) through the seed tube and out the outlet end 221 into the seed trench 262. Other types of seed delivery systems may be or may include assistive systems, in that they do not simply rely on gravity to move the seed from the metering system into the ground. Instead, such assistive systems actively assist the seeds in moving from the meter to a lower opening, where the seeds exit or are deposited into the ground or trench. The assistive systems can be systems that physically capture the seed and move the seed from the meter to the outlet end of the seed delivery system or they can be pneumatic systems that pump air through the seed tube to assist movement of the seed. The air velocity can be controlled to control the speed at which the seed moves through the delivery system.

A downforce actuator 226 is mounted on a coupling assembly 228 that couples row unit 206 to toolbar 203. Down force actuator 226 can be a hydraulic actuator, a pneumatic actuator, a spring-based mechanical actuator or a wide variety of other actuators. In the example shown in FIG. 3 rod 230 is coupled to a parallel linkage 232 and is used to exert an additional downforce (in the direction indicated by arrow 234) on row unit 206. The total downforce (which includes the force indicated by arrow 234 exerted by actuator 226, plus the force due to gravity acting on row unit 206 (and indicated by arrow 236) is offset by upwardly directed forces acting on closing wheels 218 (from ground 238) and disc opener 214 (again from ground 238). The remaining force (the sum of the force vectors indicated by arrows 234 and 236, minus the upward force on closing wheels 218 and opener 214 and the force on any other ground engaging component on the row unit (not shown)), is the differential force. The differential force may also be referred to herein as the downforce margin. The downforce margin acts on the gauge wheels 216. This load can be sensed by a gauge wheel load sensor (or down force sensor), which may be located anywhere on row unit 206 where it can sense that load. The down force sensor can also be placed where it may not sense the load directly, but a characteristic indicative of that load. For example, the down force sensor can be disposed near a set of gauge wheel control arms (or gauge wheel arm) 248 that movably mount gauge wheels 216 to shank 252 and control an offset between gauge wheels 216 and the discs in double disc opener 214, to control planting depth.

Arms (or gauge wheel arms) 248 illustratively abut against a mechanical stop (or arm contact member-or wedge) 250. The position of mechanical stop 250 relative to shank 252 can be set by a planting depth actuator assembly 254. Control arms 248 illustratively pivot around pivot point 256 so that, as planting depth actuator assembly 254 actuates to change the position of mechanical stop 250, the relative position of gauge wheels 216, relative to the double disc opener 214, changes, to change the depth at which seeds are planted.

Row unit 206 can also have one or more different sensors mounted thereon, such as a ride quality sensor 280 that senses the ride quality of row unit 206. Ride quality sensor 280 may be an inertial measurement unit, an accelerometer, or any of a wide variety of other sensors that can sense the quality (e.g., the accelerations acting on row unit 206) or bumpiness of row unit 206 as row unit 206 travels across the field. Row unit 206 can also have other sensors, such as a soil characteristic sensor (e.g., soil moisture sensor, etc.) which may be disposed on or approximate double disc opener 214, closing wheels 218, or at another location where the sensor can sense characteristics of the soil. The sensors can include pressure sensors (such as pressure sensors located in applicators 209) which may sense the pressure of material being delivered through applicator 209. The sensors may include optical or other sensors that sense residue, soil type, or other soil characteristics. Similarly, the sensors can sense the topography of the field over which row unit 206 is traveling, the orientation of row unit 206 in space, and/or any of a wide variety of other planting parameter sensors as well. The sensors can generate sensor signals indicative of the sensed variables and provide those sensor signals to speed optimization state generation system 148.

In operation, row unit 206 travels generally in the direction indicated by arrow 260. The double disc opener 214 opens a furrow 262 in the soil 238, and the depth of the furrow 262 is set by planting depth actuator assembly 254, which, itself, controls the offset between the lowest parts of gauge wheels 216 and disc opener 214. Seeds are dropped through seed tube 220, into the furrow 262 and closing wheels 218 close the furrow 262, e.g., push soil back into the furrow 262.

As the seeds are dropped through seed tube 220, the seeds can be sensed by seed sensor 222. Some examples of seed sensor 222 may include an optical or reflective sensor, which includes a radiation transmitter component and a receiver component. The transmitter component emits electro-magnetic radiation, and the receiver component then detects the radiation and generates a signal indicative of the presence or absence of a seed adjacent to the sensor. In another example, row unit 206 may be provided with a seed firmer that is positioned to travel through furrow 262, after seeds are placed in furrow 262, to firm the seeds in place. A seed sensor can be placed on the seed firmer and generate a sensor signal indicative of a seed.

The present description proceeds with respect to the seed sensor being located to sense a seed passing it in seed tube 220, but this is for the sake of example only. Material application control system 113 illustratively receives a signal from seed sensor 222, indicating that a seed is passing sensor 222 in seed tube 220. Where an intermittent application pattern is used, system 113 then determines when to actuate applicators 209 so that material being applied through application assembly 217 (and out distal tip 219 of application assembly 217) will be applied at a desired location relative to the seed in trench or furrow 262. One brief example of the operation will be described now, by way of overview.

Material application control system 113 illustratively is programmed with, or detects a distance, e.g., a longitudinal distance, that the distal tip 219 is from the exit end 221 of seed tube 220. System 113 also illustratively senses, or is provided (e.g., by another component, such as a GPS unit on a tractor, etc.), the ground speed of row unit 206. As the row units 206 on an implement being towed by a prime mover (e.g., a tractor) may move faster or slower than the tractor during turns, particularly as the width of the implement increases, the material application control system 113 may sense, compute, or be provided the ground speed of each row unit 206 of the implement. By way of example, the material application control system 113 may sense or be provided information when the implement is turning right indicating that the rightmost row unit 206 is travelling slower, i.e., has a lower ground speed, than the leftmost row unit 206. Further, the material application control system 113 detects, is provided, or is programmed with, system data indicating the responsiveness of applicators 209 under certain conditions (such as under certain temperature conditions, certain humidity conditions, certain elevations, when spraying a certain type of fluid, etc.) and the spray angle of applicators 209, (such as the size and orientation of the spray pattern emitted by applicator 209), and system 113 also detects, is provided, or programmed with one or more properties of the material being applied through applicators 209 (as this may affect the speed at which applicators 209 respond, the time it takes for the material to travel through application assembly 217 to the distal tip 219 and be applied to furrow 262, etc.). Further, material application control system 113 illustratively detects (or is provided with a sensor signal indicative of) the forward speed of row unit 206 in the direction generally indicated by arrow 260. Application control system 113 can also obtain information indicative of the duty cycle used to control applicator 209.

With this type of information, once system 113 receives a seed sensor signal indicating that a seed is passing sensor 222 in seed tube 220, system 113 determines the amount of time it will take for the seed to drop through the outlet end of seed tube 220 and into furrow 262 to reside at its final seed location and position in furrow 262. System 113 then determines when tip 219 will be in a desired location relative to that final seed location and actuates applicators 209 using a pulse width modulated control signal with a switching frequency (given the signal duty cycle) that will apply the material at the desired location. By way of example, it may be that some material is to be applied directly on the seed. In that case, system 113 times the actuation of applicators 209 so that the applied material will be applied at the seed location. In another example, it may be desirable to apply some material at the seed location and also a predetermined distance on either side of the seed location along the furrow. In that case, system 113 generates the control signal used to control applicators 209 at a switching frequency and timing so that the material is applied in the desired fashion. In other examples, it may be that the material is to be applied at a location between seeds in furrow 262. By way of example, relatively high nitrogen fertilizer may be most desirably applied between seeds, instead of directly on the seed. In that case, system 113 has illustratively been programmed with the desired location of the applied material, relative to seed location, so that system 113 can determine when, and at what frequency, to generate the control signal to actuate the control valve in applicators 209 to apply the material between seeds. Further, as discussed above, the valves in applicators 209 can be actuated to dispense material at a varying rate. Applicators 209 can dispense more material on the seed location and less at locations spaced from the seed location, or vice versa, or according to other application patterns. Different applicators 209 on the same row unit 206 can apply the same or different materials according to the same or different application patterns.

Some or all of the applicator(s) 209 may have a valve output pressure sensor that senses the pressure downstream of the valve or the pressure drop across the valve or other pressure in applicator 209.

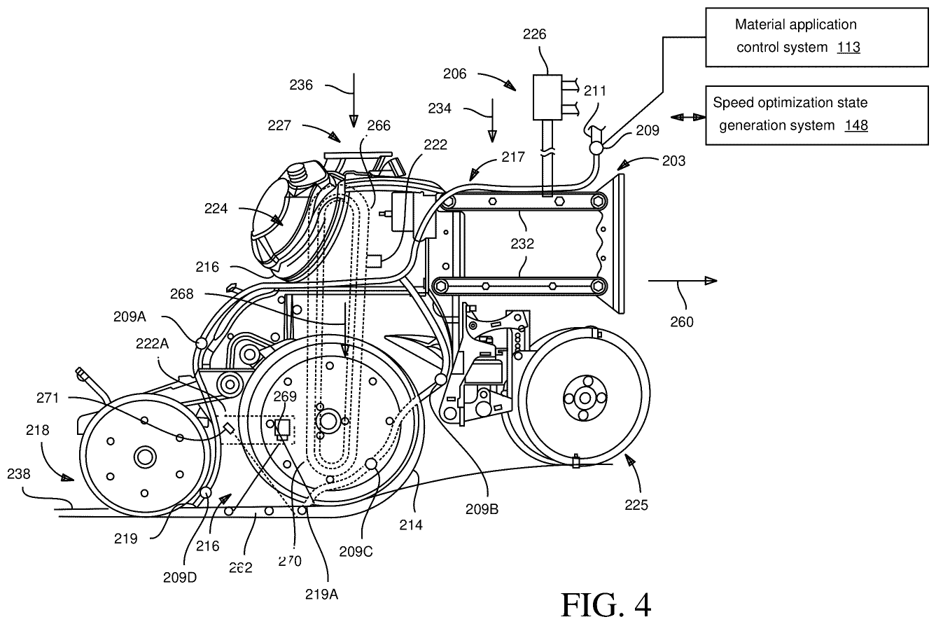

FIG. 4 is similar to FIG. 3, and similar items are similarly numbered. However, instead of the seed delivery system being a seed tube 220, which relies on gravity to move the seed to the furrow 262, the seed delivery system shown in FIG. 4 is an assistive seed delivery system 266. Also, FIG. 4 shows that row unit 206 has row cleaner 225 which clears residue and other material ahead of opener 214. In FIG. 4, row unit 206 also has a seed hopper 227 that provides seed to seed meter 224. Assistive seed delivery system 266 also illustratively has a seed sensor 222 disposed therein.

Assistive seed delivery system 266 captures the seeds as they leave seed meter 224 and moves them in the direction indicated by arrow 268 toward furrow 262. System 266 has an outlet end 270 where the seeds exit assistive system 266, into furrow 262, where they again reach their final resting location.

FIG. 4 also shows that row unit 206 may have an optical seed sensor 222A (in addition to, or instead of, seed sensor 222) with an image capture device (or camera) 269 and an illumination source 271. When the seeds are dropped into furrow 262, the seeds can be sensed by seed sensor 222A. Illumination source 271 may direct illumination onto an area of furrow 262. Camera 269 captures an image (or a sequence of images) of the illuminated area. An image processing system (located on sensor 222A, material application control system 113, at a remote location, and/or elsewhere) processes the image(s) to identify planting characteristics, such as seed location, seed type, seed orientation, seed (or furrow) depth, seed spacing, seed-to-soil contact, furrow integrity, anomalous material (such as rocks, plant matter, etc.), and/or other planting characteristics. The optical seed sensor 222A can be placed in a variety of different locations on row unit 206, or on different components of row unit 206, to obtain an image (or a sequence of images) of seeds in the furrow 262.

In a system where seed sensor 222 is used, material application control system 113 considers the speed at which delivery system 266 moves the seed from seed sensor 222 to the exit end 270. System 113 also illustratively considers the speed at which the seed moves from the exit end 270 into furrow 262. For instance, in one example the seed simply drops from exit end 270 into furrow 262 under the force of gravity. In another example, however, the seed can be ejected from delivery system 266 at a greater or lesser speed than that which would be reached under the force of gravity. Similarly, it may be that the seed drops straight downward into furrow 262 from the outlet end 270. In another example, however, it may be that the seed is propelled slightly rearwardly from the outlet end 270, to accommodate for the forward motion of the row unit 206, so that the travel path of the seed is more vertical and so the seed rolls less once it reaches the furrow. Further, the seed can be ejected rearwardly and trapped against the ground by a trailing member (such as a pinch wheel) which functions to stop any rearward movement of the seed, after ejection, and to force the seed into firm engagement with the ground.

Again, FIG. 4 also shows that a plurality of applicators 209 can be placed at any of a wide variety of different locations, some of which are illustrated by numbers 209A, 209B, 209C, and 209D.

Where optical seed sensor 222A is used, material application control system 113 illustratively receives a signal from seed sensor 222A, indicating the planting characteristics discussed above, or other planting characteristics. Material application control system 113 can also receive a ground speed signal indicative of a speed of movement of row unit 206, and then determines when, and at what frequency, to independently actuate the different actuators in the applicators 209 on row unit 206 so that material being applied through application assemblies 217 (and out distal tips 219 of application assemblies 217) will be applied at a desired location relative to the seed in trench or furrow 262, or according to a desired application pattern, and/or based on other planting characteristics identified by processing the image(s) captured by optical seed sensor 222A. There can be more than one seed sensor, seed sensors of different types, different locations for seed sensors, etc.

FIG. 4 also shows that row unit 206 can include sensors that provide signals to speed optimization state generation system 148 for generation of the speed optimization state signal. Such sensors can include a downforce sensor, a ride quality sensor, a pressure sensor that senses pressure of commodity upstream or downstream of applicators 209, wheel slip sensors, soil condition sensors, and/or any of a wide variety of other sensors. Some examples of such sensors are described elsewhere herein. The values provided in the sensor signals are evaluated to determine whether the planter should be traveling faster, slower, or at the same speed, and generate a speed optimization state signal indicative of the determination. Based on the speed optimization state signal, the speed control system in tractor 106 can control the propulsion system 150 to automatically control the ground speed of tractor 106 (and hence row unit 206).

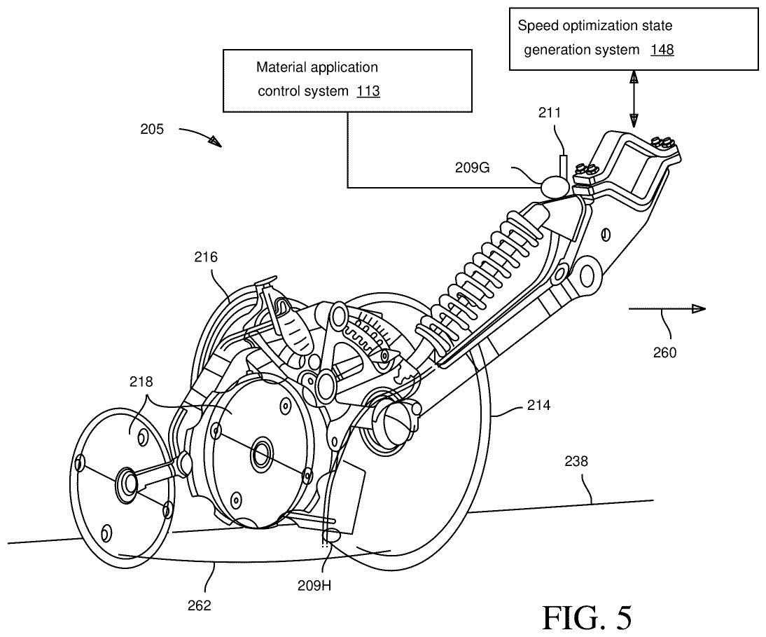

FIG. 5 is a side perspective view of an applicator unit 205. Some items are similar to those shown in other FIGS. and these items are similarly numbered. Briefly, in operation, applicator unit 205 attaches to a side-dress bar that is towed behind a towing vehicle or tractor 106, so unit 205 travels between rows (if the rows are already planted). However, instead of planting seeds, applicator unit 205 applies material at a location between rows of seeds (or, if the seeds are not yet planted, between locations where the rows will be, after planting). When traveling in the direction indicated by arrow 260, disc opener 214 (in this example, it is a single disc opener) opens furrow 262 in the ground 238, at a depth set by gauge wheel 216. Applicator unit 205 can have a plurality of independently controllable applicators 209. When applicators 209 are actuated, material is applied in furrow 262 and closing wheels 218 then close the furrow 262.

As unit 205 moves, material application control system 113 controls applicators 209 to dispense material. This can be done relative to seed or plant locations, if those locations are sensed or are already known or have been estimated. Application can also be done before the seed or plant locations are known. In this latter scenario, the locations where the material is applied can be stored so that seeds can be planted later, relative to the locations of the material that has been already dispensed.

FIG. 5 shows that applicators 209, or components of applicators 209, can be mounted to any of a plurality of different positions on unit 205. Two of the positions are shown at 209G and 209H. These are examples and applicators 209 can be located elsewhere as well. Similarly, multiple applicators 209 can be disposed on unit 205 at different locations, or adjacent one another, to dispense multiple different materials or to dispense material in a more rapid or more voluminous way or to dispense the same material at different rates or according to different application patterns.

FIG. 5 also shows that unit 205 can send sensor signals to speed optimization state generation system 148. Based on those sensor signals, system 148 can generate a speed optimization state signal that can be used to control the ground speed of towing vehicle or tractor 106.

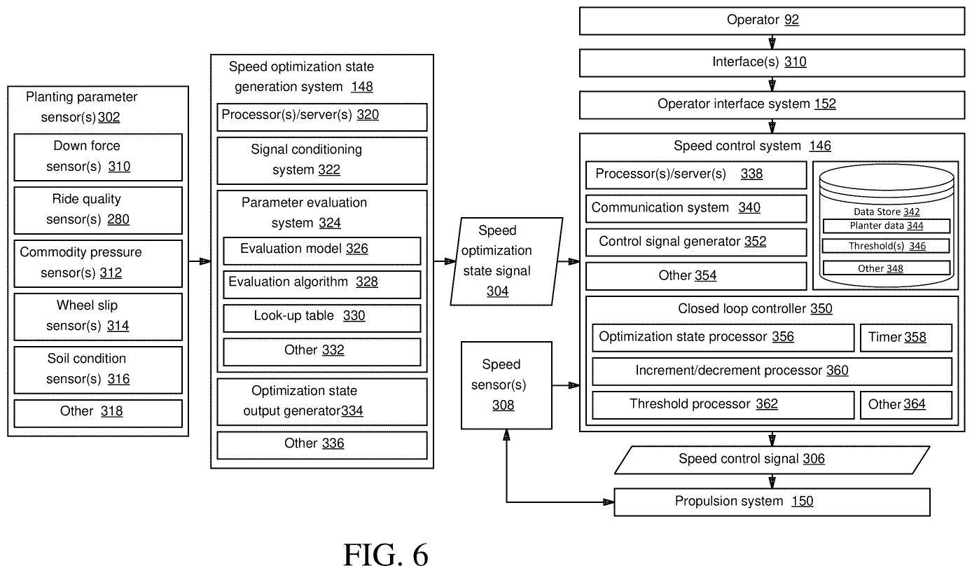

FIG. 6 is a block diagram showing one example of an agricultural system 300 that includes a plurality of planting parameter sensors 302 that provide sensor signals to speed optimization state generation system 148. Based on the sensor signals, speed optimization state generation system 148 generates speed optimization state signal 304. Speed optimization state signal 304 indicates whether the ground speed of tractor 106 should be increased, decreased, or maintained the same based upon the parameters sensed by the planting parameter sensors 302. FIG. 6 also shows that speed control system 146 generates a speed control signal 306 to control the propulsion system 150 on tractor 106. A speed sensor 308 senses the ground speed of tractor 106 (e.g., by sensing the speed of propulsion system 150 or in other ways) and provides a speed sensor signal back to speed control system 146. FIG. 6 also shows that operator interface system 152 can be used to generate interfaces 310 for interaction by operator 92. Operator 92 can interact with interfaces 310 to control and manipulate some portions of speed control system 146.

In the example shown in FIG. 6, planting parameter sensors 302 can include downforce sensor 310, ride quality sensor 280, commodity pressure sensor 312, wheel slip sensor 314, soil condition sensor 316, and any of a wide variety of other sensors 318. Speed optimization state generation system 148 can include one or more processors or servers 320, signal conditioning system 322, parameter evaluation system 324 (which, itself, can include evaluation model 326, evaluation algorithm 328, lookup table 330, and/or other items 332), optimization state output generator 334, and other items 336. Speed control system 146 can include one or more processors or servers 338, communication system 340, data store 342 (which can include planter data 344, one or more speed thresholds 346, and other items 348), closed loop controller 350, control signal generator 352, and/or any of a wide variety of other items 354. Closed loop controller 350 can include one or more optimization state processors 356, timer 358, increment/decrement processor 360, threshold processor 362, and/or other items 364. Before describing the overall operation of agricultural system 300 in more detail, a description of some of the items in agricultural system 300, and their operation, will first be provided.

Downforce sensor 310 can be any of wide variety of different types of sensors that sense the force output by downforce actuator 226, or that sense the downforce margin on the row unit 206. Downforce sensor 310 thus converts a mechanical force into an electrical signal. Downforce sensor 310 can thus be a capacitive force sensor, a piezoelectric force sensor, a piezoresistive force sensor, a strain gauge, or another type of force sensor.

Ride quality sensor 280, as discussed above, can be an inertial measurement unit, and accelerometer, a gyroscopic sensor, or another sensor that can generate an output indicative of accelerations or other forces imparted on the row unit 206 that affect ride quality.

The commodity pressure sensor 312 may be a sensor that senses the pressure of commodity that is being applied by applicators 209. For instance, where applicator 209 includes a valve, the commodity pressure sensor 312 may be a diaphragm sensor disposed upstream of the valve to sense pressure in the conduit upstream of the valve. Commodity pressure sensor 312 may also be disposed downstream of the valve or disposed to detect a pressure drop across the valve. The commodity pressure sensor 312 may be a different type of sensor as well. Commodity pressure sensor 312 may be a central pressure sensor that senses commodity pressure of commodity being delivered to a plurality of different row units 206 and/or a plurality of different applicators 209 as well.

Wheel slip sensor 314 may sense wheel slip on tractor 106 or elsewhere. The wheel slip sensor 314 may receive an output from a traction control system indicative of the slippage of the drive wheels on tractor 106. Wheel slip sensor 314 may sense wheel slip in other locations and in other ways as well.

Soil condition sensor 316 may sense any of a wide variety of different types of soil can additions. The sensed soil conditions can include such things as soil moisture, soil type, the level of different constituents in the soil, and/or any of wide variety of other soil conditions. Soil condition sensor 316 may be a capacitive sensor, an image capture and image processing sensor, or any of a wide variety of other sensors.

Other sensors 318 may include such things as a position sensor (which may be a global navigation satellite system-a GNSS receiver-a dead reckoning system, a cellular triangulation system, etc.), a topography sensor or machine orientation sensor (which may be an accelerometer, a gyroscopic sensor, or another sensor that senses machine orientation in space), and/or any of wide variety of other sensors.

In speed optimization state generation system 148, signal conditioning system 322 may receive sensor signals from the planting parameter sensors 302 and perform conditioning operations on those sensor signals. The conditioning operations can include such things as filtering, amplification, normalization, aggregation, and/or other conditioning operations.

Parameter evaluation system 324 evaluates the parameters sensed by the planting parameter sensors to determine whether the ground speed of the planter can be increased, decreased, or maintained the same to achieve desired planting performance. Thus, parameter evaluation system 324 can use an evaluation model 326, evaluation algorithm 328, look-up table 330, or another evaluation component 332.

Evaluation model 326 receives, as inputs, the values of the parameters sensed by planting parameter sensors 302 and generates an output indicating a speed optimization state. The speed optimization state illustratively indicates whether the ground speed of the planter should be increased, decreased, or maintained the same to achieve desired planting operation performance.

Evaluation model 326 may be a static or dynamic model that may include machine learning model(s), such as artificial neural network(s), artificial intelligence (AI) classifier(s) (such as large language model(s)), and/or other models. Such models are trained on the values of planting parameters in contexts where ground speed should be increased, decreased, and maintained. The models can be trained using supervised training, unsupervised training, and/or any of a wide variety of different training techniques.

Evaluation algorithm 328 me may be a rules-based algorithm, or another algorithm. Evaluation algorithm 328 receives the values of the parameters sensed by planting parameter sensors 302 as an input and generates an output indicative of the speed optimization state. Again, the speed optimization state can indicate that the ground speed of the planter should be increased, decreased, or maintained the same to achieve desired planting operation performance.

Look-up table 330 may be a table of speed optimization states indexed based on planting parameter values. Therefore, the values of the parameters sensed by planting parameter sensors 302 can be used to index into look-up table 330 to identify the speed optimization state. The speed optimization state will thus identify whether the ground speed of the planter should be increased, decreased, or maintained to achieve desired planting operation performance based on the sensed planting parameters.

Optimization state output generator 334 receives the output of the parameter evaluation system 324 and generates speed optimization state signal 304. Speed optimization state signal 304 illustratively identifies the speed optimization state so that the speed optimization state can be used by speed control system 146 to generate speed control signal 306. It will also be noted that, in one example, the speed optimization state signal 304 is updated or sampled periodically or otherwise intermittently, such as every second, every minute, every time a sensed parameter changes by a threshold amount, or otherwise intermittently. The time at which the speed optimization state signal 304 is updated or sampled can be set by timer 358 or in another way.

Operator interface system 152 can include wide variety of different types of operator interface mechanisms, such as a steering wheel, a joystick, pedals, linkages, levers, buttons, and/or a display screen that outputs information to operator 92 and that receives input from operator 92 through such things as links, icons, buttons, drop-down menus, etc. The display screen may be a touch sensitive screen and be mounted in tractor 106 or on a mobile device or elsewhere. Operator interface system 152 can include a microphone and speakers (such as where speech-enabled operations are supported), and/or any other mechanisms that provide audio, visual, and/or haptic outputs to operator 92 or receive inputs from operator 92.

Communication system 340 facilitates the communication of items in agricultural system 300 with one another and may facilitate communication with other systems or other machines directly or over a network. Therefore, communication system 340 may be a controller area network (CAN) bus and bus controller, a cellular communication system, a near field communication system, a BLUETOOTH™ or WI-FI™ communication system, a wide area network communication system, a local area network communication system, or any of a wide variety of other communication systems or combinations of systems.

In data store 342, planter data 344 may identify the type of planter, the dimensions of the planter, relationships between desired planting speed and parameter values, parameters or coefficients or other values that may be used by evaluation model 326, evaluation algorithm 328, and/or look-up table 330, or any of wide variety of other values that may indicate how the tractor speed should be controlled based upon the speed optimization state. Speed thresholds 346 may indicate a maximum speed corresponding to the planter and/or corresponding to the tractor 106, and/or other speed thresholds that may be used to control the tractor speed.

To initiate the planting operation, operator 92 may provide a speed set point through operator interface system 152. The speed set point can be provided to closed loop controller 350 which generates an output indicative of the speed at which the tractor 106 should be controlled. Control signal generator 352 then generates speed control signal 306 to control propulsion system 150 based upon the speed set point. The propulsion system 150 propels tractor 106 at the ground speed indicated by the speed set point. Speed sensor 308 senses the actual ground speed of the tractor 106 and provides a speed sensor signal back to closed loop controller 350. Closed loop controller 350 performs closed loop control of the tractor speed by adjusting the output of closed loop controller 350 to control signal generator 352 so that a modified speed control signal 306 can be generated to bring the ground speed of tractor 106 (as measured by the speed sensor 308) closer to the speed indicated by the speed set point.

Also, during the planting operation, closed-loop controller 350 intermittently receives and evaluates the speed optimization state signal 304 which identifies the speed optimization state. For example, timer 358 may set a timeout period and optimization state processor 356 obtains and evaluates the speed optimization state identified in speed optimization state signal will 304 once for every timeout period. Optimization state processor 356 processes the speed optimization state signal 304 to identify the speed optimization state. Increment/decrement processor 360 increments or decrements the speed set point, or maintains the speed set point, based upon the speed optimization state. Threshold processor 362 determines whether an incremented or decremented speed set point has reached a threshold value 346 (such as the maximum speed of tractor 106 or the maximum speed of planter 102, 202, such as whether the current speed is already zero and the speed optimization state indicates that the speed should be decremented, etc.). If threshold processor 362 determines that the modified speed set point would cross a threshold value 346, then closed loop controller 350 does not change the speed set point but maintains it at the same value. Closed-loop controller 350 then outputs the new speed set point (e.g., the incremented set point, the decremented set point, or the maintained set point) and control signal generator 352 generates the speed control signal 306 to control propulsion system 150 to propel tractor 106 based on the new speed set point.

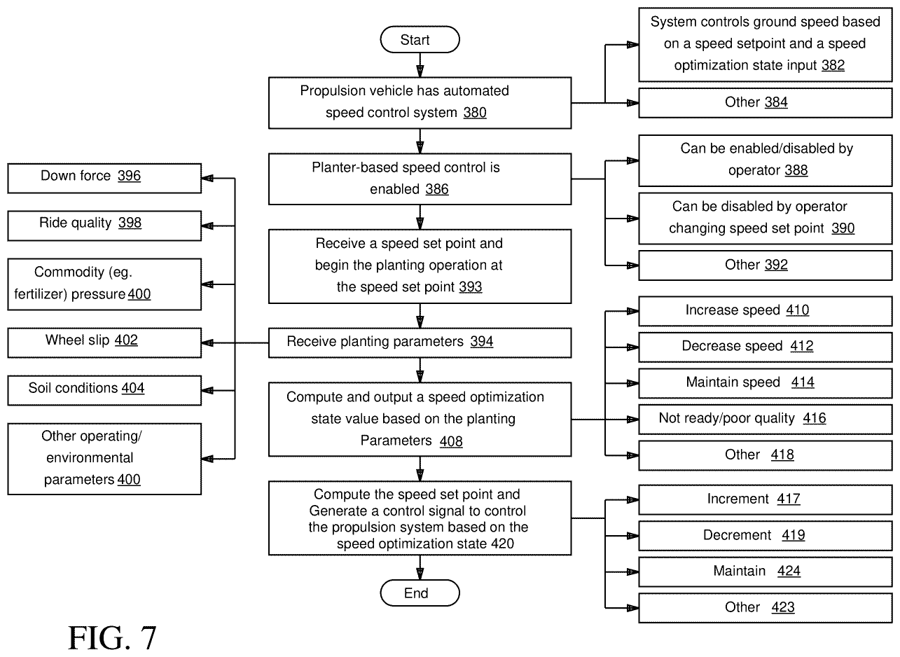

FIG. 7 is a flow diagram illustrating one example of the operation of agricultural system 300. It is assumed that the propulsion vehicle (e.g., tractor) 106 has an automated speed control system 146 as indicated by block 380. Speed control system 146 automatically controls the ground speed of tractor 106 based upon a speed set point and a speed optimization state input, as indicated by block 382. The speed control system 146 can perform other operations as well, as indicated by block 384.

Also, in one example, operator 92 can enable and disable speed control based upon the speed optimization state in speed optimization state signal 304 (e.g., operator 92 can enable and disable the planter-based speed control). It is assumed, for the sake of the discussion of FIG. 7, that the planter-based speed control is enabled, as indicated by block 386. Operator 92 may be able to enable or disable such speed control through interfaces 310, as indicated by block 388. Also, in one example, even where the planter-based speed control is enabled, if operator 92 provides a different speed set point through operator interface system 152, then speed control system 146 will automatically begin performing closed-loop control based upon that speed set point and disable planter-based speed control. Having the planter-based speed control disabled by having the operator 92 change the speed set point is indicated by block 390 in the flow diagram of FIG. 7. The planter-based speed control can be enabled and disabled in other ways as well, as indicated by block 392.

At some point, to begin the planting operation, speed control system 146 receives a speed set point from the operator 92 as indicated by block 393. Closed-loop controller 350 then begins performing closed-loop control of propulsion system 150 based upon the speed set point.

Speed optimization state generation system 148 receives the sensor signals from the planting parameter sensors 302, as indicated by block 394 in FIG. 7. The sensed planting parameters can include such things as downforce 396, ride quality 398, commodity pressure 400, wheel slip 402, soil conditions 404, and/or any of a wide variety of other operating or environmental parameters (e.g., planting parameters) 406.

Speed optimization state generation system 148 then evaluates the planting parameters and computes a speed optimization state value based upon the planting parameters. These speed optimization state value can be generated using evaluation model 326, evaluation algorithm 328, look-up table 330, or any of a wide variety of other evaluation systems 332. Computing the speed optimization state value based upon the planting parameters is indicated by block 408 and FIG. 7.

The value of the speed optimization state can indicate a variety of different speed operations. For instance, the speed optimization state can indicate that the speed should be increased, as indicated by block 410, decreased, as indicated by block 412, or maintained the same, as indicated by block 414. In some examples, the value of the speed optimization state may indicate that the planter is not ready to perform planter-based speed control, for variety of reasons, or that the planting parameter sensor signals or the speed optimization state signal 304 is poor quality due to noise, or due to other criteria. Providing the speed optimization state value to indicate that the planter is not ready or that the signals are of poor quality is indicated by block 416 and the flow diagram of FIG. 7. The speed optimization state value can be computed in a wide variety of other ways as well, as indicated by block 418.

Control signal generator 352 generates speed control signal 306 to control propulsion system 150 based upon the speed optimization state, as indicated by block 420. Where the speed optimization state indicates that the speed set point should be changed (e.g., incremented or decremented), then increment/decrement processor 360 generates an output indicating that the speed set point should be incremented or decremented by a predetermined value (such as by 1 mph or kph, 2 mph or kph, etc.). Control signal generator 352 can generate speed control signal 306 to increment the ground speed as indicated by block 417, to decrement the ground speed as indicated by block 419, to maintain the ground speed at a current level, as indicated by block 421, or to control the ground speed in other ways, as indicated by block 423.

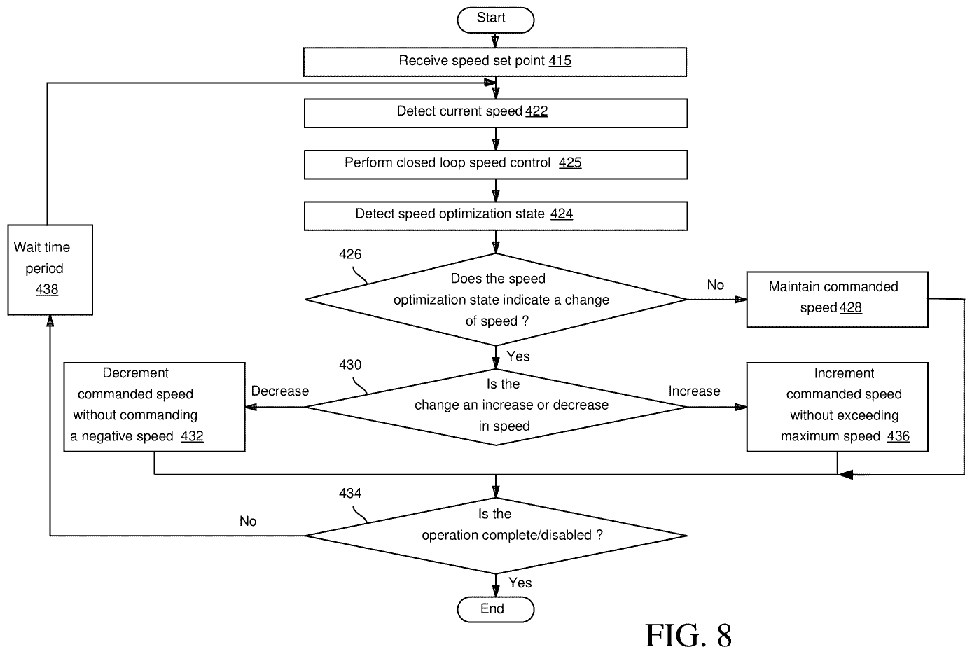

FIG. 8 is a flow diagram illustrating one example of the operation of speed control system 146 in reacting to speed optimization state signal 304. It is first assumed that closed-loop controller 350 receives a speed set point, as indicated by block 415 in the flow diagram of FIG. 8. The speed set point can be received from operator 92 or elsewhere. Closed-loop controller 350 also receives a sensor signal indicative of the current speed of tractor 106 or planter 102, 202 from speed sensor 308, as indicated by block 422. Closed-loop controller 350 then performs closed-loop speed control using the speed set point and the current speed, as indicated by block 425.

At some point, such as after a timeout period generated by timer 358, optimization state processor 356 processes the speed optimization state signal 304 to identify the speed optimization state represented in the speed optimization state signal 304. Detecting the speed optimization state as indicated by block 424 in the flow diagram of FIG. 8.

Increment/decrement processor 360 then determines whether the speed set point should be increased, decreased, or maintained the same, based upon the speed optimization state identified by optimization state processor 356. If the speed optimization state does not indicate any change of speed (meaning that the speed should be maintained as it is), as determined at block 426, then increment increment/decrement processor 360 generates an output to control signal generator 352 indicating that the current set point should be maintained, and control signal generator 352 generates speed control signal 306 to maintain the currently commanded speed, as indicated by block 428. Closed loop control based on the currently commanded speed continues.

However, if, at block 426, it is determined that the speed set point is to be changed, then increment/decrement processor 360 determines whether the speed is to be increased or decreased, as determined at block 430 in the flow diagram of FIG. 8. If the speed optimization state indicates that the speed should be decreased, then increment/decrement processor 360 generates an output indicating that the commanded speed set point should be decreased by a predetermined amount. Threshold processor 362 determines whether the speed decrement will meet or pass a threshold (such as to command a negative speed). The threshold determination helps to ensure that closed-loop controller 350 generates an output to control signal generator 352 indicating that control signal generator 352 should decrement the commanded speed set point by a predetermined amount, without commanding a negative speed (or crossing another threshold speed value), as indicated by block 432 in the flow diagram of FIG. 8.

Until the planting operation is complete, as in determined at block 434, timer 358 begins timing out the wait time period as indicated by block 438 in the flow diagram of FIG. 8, and processing reverts to block 422 were closed-loop controller 350 continues to perform closed-loop control based on the current speed set point and the sensed speed signal received from speed sensor 308, until a new speed optimization state signal 304 is to be evaluated.

Returning to block 430 in FIG. 8, if increment/decrement processor 360 determines that the optimization state indicates that the speed should be increased, then threshold processor 362 determines whether an increment in the speed set point will cross a speed threshold (such as the maximum speed of tractor 106 or planter 102, 202, or another speed threshold). The threshold determination helps to ensure that closed-loop controller 350 generates an output to increment the commanded speed set point without exceeding any speed threshold values. Incrementing the commanded speed set point while respecting speed thresholds is indicated by block 436 in the flow diagram of FIG. 8.

It can thus be seen that the present description proceeds with respect to a system that monitors planting parameters and automatically evaluates those parameters to generate a speed optimization state. The speed optimization state indicates that the planter speed should be increased, decreased, or maintained the same. The speed optimization state is provided to a speed control system which automatically controls the speed of the tractor (and thus the planter) based on the speed optimization state, to increase, decrease, or maintain the ground speed of tractor and hence planter. This allows the system to continuously adjust the ground speed of the tractor and planter based upon changing planting parameters, dynamically, as those parameters change. This increases the accuracy and efficiency of the planting operation, while reducing operator fatigue and error.

The present discussion has mentioned processors and servers. In one example, the processors and servers include computer processors with associated memory and timing circuitry, not separately shown. The processors and servers are functional parts of the systems or devices to which they belong and are activated by and facilitate the functionality of the other components or items in those systems.

It will be noted that the above discussion has described a variety of different systems, components, models, generators, algorithms, sensors, and/or logic. It will be appreciated that such systems, components, models, generators, algorithms, sensors, and/or logic can be comprised of hardware items (such as processors and associated memory, or other processing components, some of which are described below) that perform the functions associated with those systems, components, models, generators, algorithms, sensors, and/or logic. In addition, the systems, components, models, generators, algorithms, sensors, and/or logic can be comprised of software that is loaded into a memory and is subsequently executed by a processor or server, or other computing component, as described below. The systems, components, models, algorithms, sensors, generators, and/or logic can also be comprised of different combinations of hardware, software, firmware, etc., some examples of which are described below. These are only some examples of different structures that can be used to form the systems, components, models, algorithms, sensors, generators, and/or logic described above. Other structures can be used as well.

Also, a number of user interface (UI) displays have been discussed. The UI can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, they can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

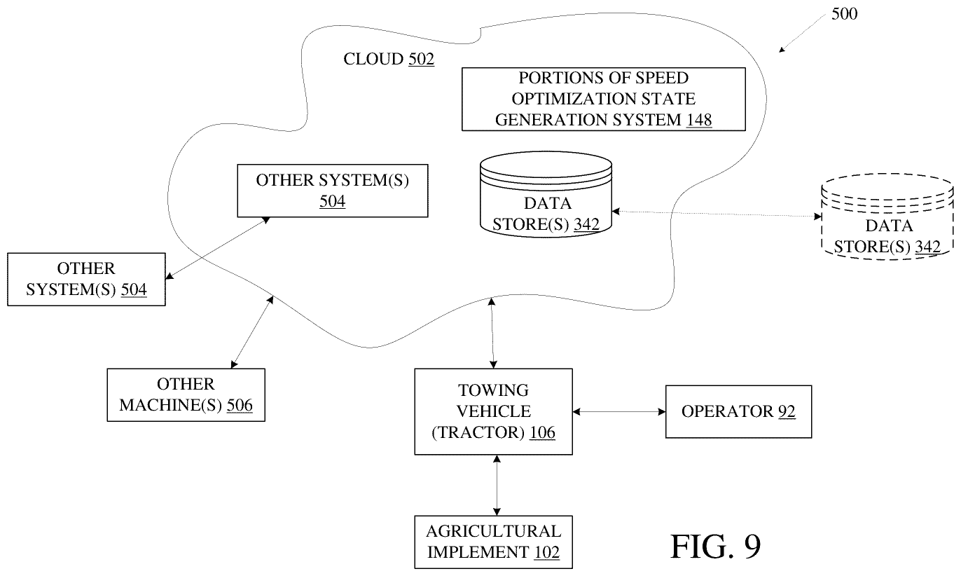

FIG. 9 is a block diagram of the architecture, shown in FIG. 1, except that some elements are disposed in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in other FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

Other systems 504 can include farm manager systems, vendor systems, maintenance systems, cloud-based systems or any of wide variety of other systems. Other machines 506 can include towing vehicle or tractor 106, tender vehicles, other planting machines, and/or any of wide variety of other machines.

In the example shown in FIG. 9, some items are similar to those shown in FIGS. 1-8 and they are similarly numbered. FIG. 9 specifically shows that some portions of speed optimization state generation system 148 and data store 342, or other systems 504, can be located at a remote server location 502. Therefore, parts of system 148 can access those systems through remote server location 502. FIG. 9 also shows that other machines 506 and/or other systems 504 can communicate with remote server environment 502.

FIG. 9 also depicts another example of a remote server architecture. FIG. 9 shows that it is also contemplated that some elements of other FIGS. can be disposed at remote server location 500 while others are not. By way of example, data store 342 can be disposed at a location separate from location 500 and accessed through the remote server at location 500. Regardless of where the elements are located, the elements can be accessed directly by system 148 or other systems, through a network (either a wide area network or a local area network), the elements can be hosted at a remote site by a service, or the elements can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the planter or tractor comes close to the fuel truck for fueling, the system automatically collects the information from the planter or tractor using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the planter or sprayer until the planter or tractor enters a covered location. The planter or tractor, itself, can then send the information to the main network.

It will also be noted that the elements of other FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

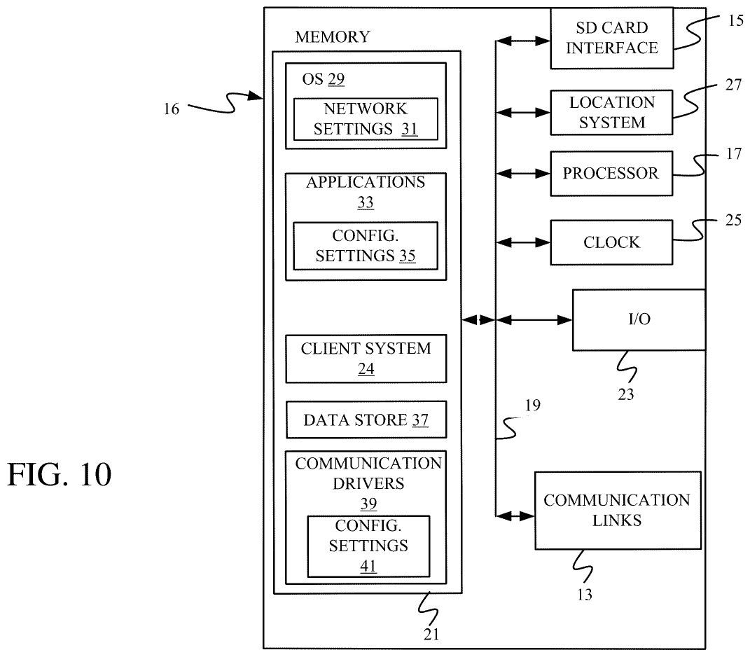

FIG. 10 is a simplified block diagram of one illustrative example of a handheld or mobile computing device that can be used as a user's or client's handheld device 16, in which the present system (or parts of it) can be deployed. For instance, a mobile device can be deployed in the operator compartment of towing vehicle or tractor 106 for use in generating, processing, or displaying the speed data or planting parameter data. FIGS. 10-12 are examples of handheld or mobile devices.

FIG. 10 provides a general block diagram of the components of a client device 16 that can run some components shown in other FIGS., that interact with those components, or both. In the device 16, a communications link 13 is provided that allows the handheld device to communicate with other computing devices and in some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a GNSS, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

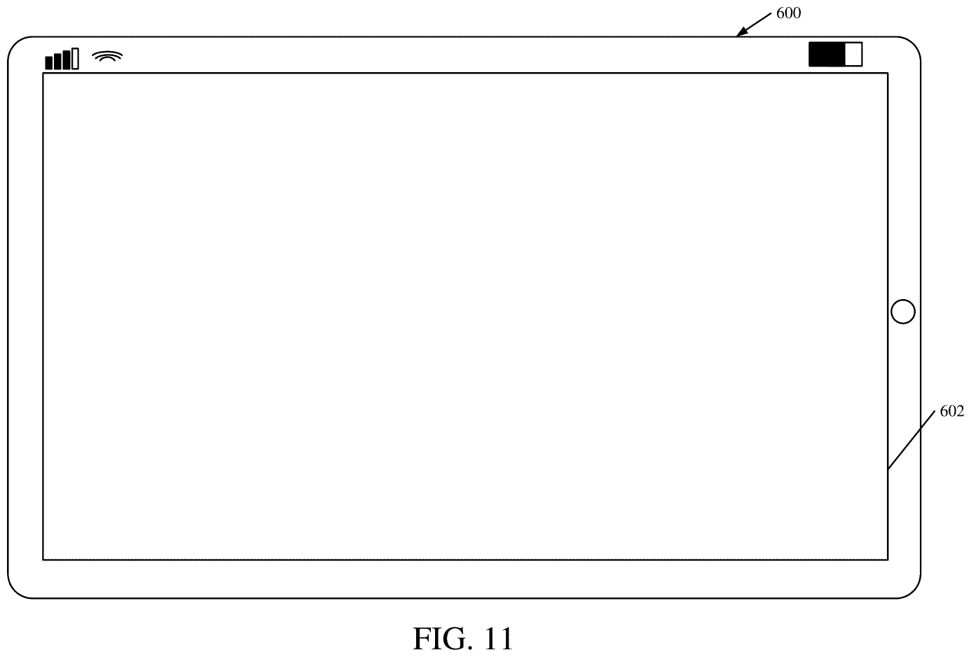

FIG. 11 shows one example in which device 16 is a tablet computer 600. In FIG. 11, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

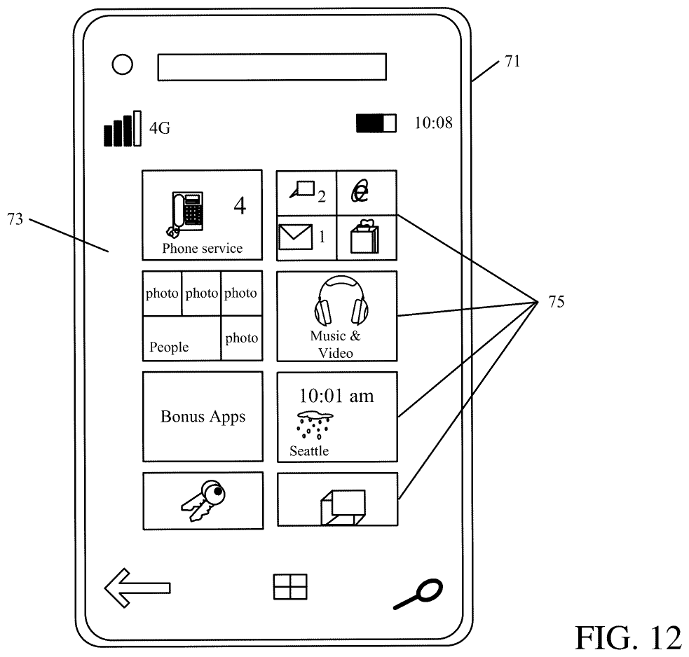

FIG. 12 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

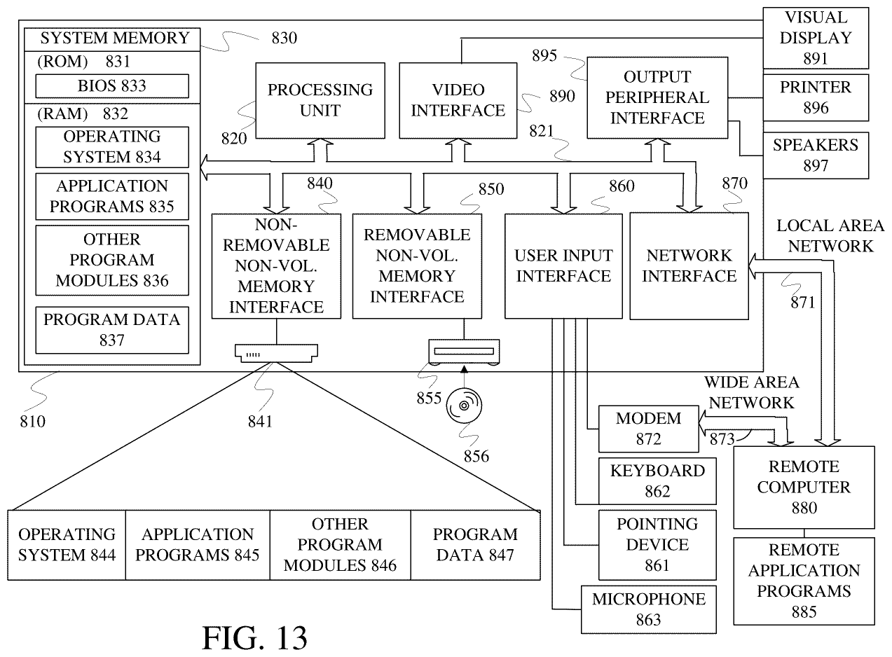

FIG. 13 is one example of a computing environment in which elements of other FIGS., or parts of it, (for example) can be deployed. With reference to FIG. 13, an example system for implementing some embodiments includes a computing device in the form of a computer 810 programmed to operate as described above. Components of computer 810 may include, but are not limited to, a processing unit 820 (which can comprise processors or servers from previous Figures), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to other FIGS. can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

System memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 13 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method, comprising:
receiving a planting parameter signal indicative of a parameter corresponding to a planting machine during a planting operation, the parameter comprising at least one of:
a seed ground contact, seed population, fertilizer application rate, engine power, a value indicative of traction, or a pressure in an application system on the planting machine;
generating a speed state signal having a speed state value indicative of a modification to a ground speed of the planting machine based on the planting parameter signal; and
automatically controlling a ground speed of a propulsion vehicle based on the speed state value.

2. The computer implemented method of claim 1 and further comprising:
prior to generating the speed state signal, automatically controlling the ground speed of the propulsion vehicle based on a first speed set point.

3. The computer implemented method of claim 2 wherein automatically controlling the ground speed of the propulsion vehicle comprises:
modifying the first speed set point based on the speed state value to obtain a modified speed set point; and
automatically controlling the ground speed of the propulsion vehicle based on the modified speed set point.

4. The computer implemented method of claim 3 wherein generating the speed state signal with the speed state value comprises:
generating the speed state signal with a first speed state value indicative of an increment to the ground speed of the planting machine.

5. The computer implemented method of claim 4 wherein modifying the first speed set point based on the first speed state value comprises:
incrementing the first speed set point by a predetermined amount based on the first speed state value, to obtain an incremented speed set point, and wherein automatically controlling the ground speed of the propulsion vehicle based on the modified speed set point comprises automatically controlling the ground speed of the propulsion vehicle based on the incremented speed set point.

6. The computer implemented method of claim 3 wherein generating the speed state signal with the speed state value comprises:
generating the speed state signal with a second speed state value indicative of a decrement to the ground speed of the planting machine.

7. The computer implemented method of claim 6 wherein modifying the first speed set point based on the speed state value comprises:
decrementing the first speed set point by a predetermined amount based on the second speed state value, to obtain a decremented speed set point, and wherein automatically controlling the ground speed of the propulsion vehicle based on the modified speed set point comprises automatically controlling the ground speed of the propulsion vehicle based on the decremented speed set point.

8. The computer implemented method of claim 2 wherein generating the speed state signal with the speed state value comprises:
generating the speed state signal with a third speed state value indicative of no change to the ground speed of the planting machine, wherein automatically controlling a ground speed of the propulsion vehicle based on the third speed state value comprises continuing to control the ground speed of the propulsion vehicle based on the first speed set point.

9. The computer implemented method of claim 3 wherein automatically controlling the ground speed of the propulsion vehicle based on the modified speed set point comprises:
determining whether the modified speed set point meets a speed threshold; and
if so, continuing to control the ground speed of the propulsion vehicle based on the first speed set point.

10. The computer implemented method of claim 1 wherein generating a speed state signal comprises:
applying the parameter to a machine learning model; and
generating the speed state value with the machine learning model.

11. An agricultural system, comprising:
a propulsion vehicle having a propulsion system configured to provide propulsion to a planting machine;
a parameter evaluation system configured to receive a planting parameter signal indicative of a parameter corresponding to the planting machine during a planting operation and generate a speed state signal having a speed state value based on the planting parameter signal; and
a closed loop speed controller configured to intermittently modify a speed set point based on the speed state signal, a defined time period, and a detected ground speed of the planting machine, and to automatically control the propulsion system to control a ground speed of the propulsion vehicle based on the modified speed set point.

12-13. (canceled)

14. The agricultural system of claim 11 wherein the closed loop speed controller comprises:
a threshold processor configured to determine whether the modified speed set point meets a speed threshold, and, if so, generate a threshold output signal, the closed loop controller being configured to continue to control the ground speed of the propulsion vehicle based on the first speed set point in response to the threshold output signal.

15. The agricultural system of claim 11 wherein the parameter evaluation system comprises:
a machine learning model configured to receive the planting parameter signal and generate the speed state value based on the planting parameter signal.

16. The agricultural system of claim 11 wherein the parameter evaluation system comprises:
an evaluation algorithm configured to receive the planting parameter signal and generate the speed state value based on the planting parameter signal.

17. The agricultural system of claim 11 wherein the parameter evaluation system comprises:
a look-up table configured to store speed state values based on planting parameter values.

18. The agricultural system of claim 11 and further comprising:
a planting parameter sensor mounted to the planting machine and configured to sense the planting parameter signal and to generate the planting parameter signal.

19. A method, comprising:
detecting a value, sensed on a planting machine;
accessing a mapping data store that maps speed state values to corresponding planting parameter values;
selecting a speed state value, from the mapping data store, based on the detected value; and
automatically controlling a speed of a driving vehicle, that propels the planting machine, based on the value sensed on the planting machine.

20. The method of claim 19 wherein detecting a value comprises:
detecting at least one of down force, a soil condition ground contact, seed population, fertilizer application rate, engine power, a value indicative of traction, or a pressure in an application system on the planting.

21. The method of claim 19, wherein mapping data store comprises a look-up table.

22. The agricultural system of claim 11, wherein the closed loop speed controller is configured to update or sample the speed state signal intermittently based on the defined time period.
